(19) United States
(12) Patent Application Publication
(10) Pub. No.: US 2007/0019039 A1
(43) Pub. Date: Jan. 25, 2007

(54) Thermally driven inkjet printhead

(76) Inventors: Jin-wook Lee, Seoul (KR); Sung-joon Park, Suwon-si (KR); Myong-jong Kwon, Suwon-si (KR); Yong-shik Park, Seongnam-si (KR)

Correspondence Address: STANZIONE & KIM, LLP, 919 18TH STREET, N.W., SUITE 440, WASHINGTON, DC, 20006, US

(21) Appl. No.: 11/402,905

(22) Filed: Apr. 13, 2006

(30) Foreign Application Priority Data
Jul. 20, 2005 (KR) 2005-65705

(51) Int. Cl. B41J 2/05

(52) U.S. Cl. 347/65

(57) ABSTRACT

A thermally driven inkjet printhead includes a substrate, a heater formed on the substrate, a chamber layer stacked on the substrate to define an ink chamber on an upper portion of the heater and an ink feed hole to supply ink to the ink chamber at one side of the ink chamber, an intermediate layer stacked on the chamber layer in which a through hole connected to the ink chamber is formed, and a nozzle layer stacked on the intermediate layer in which a nozzle connected to the through hole is formed. The through hole is connected to the ink feed hole and has a smaller cross-sectional area than a size of the heater.

### CROSS-REFERENCE TO RELATED APPLICATIONS

This application claims priority from Korean Patent Application No. 2005-65705, filed on Jul. 20, 2005 in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to a thermally driven inkjet printhead with improved image quality.

2. Description of the Related Art

An inkjet printhead is a device that ejects fine droplets of ink having predetermined colors onto desired positions of a recording medium in order to print an image. Inkjet printheads can be classified into two types according to an ink droplet ejecting mechanism. One of the types is a thermally driven inkjet printhead that generates bubbles in the ink using a thermal source and ejects the ink droplets when the bubbles expand. The other type is a piezoelectrically driven inkjet printhead that utilizes the deformation of a piezoelectric material to eject the ink droplets.

The ink droplet ejecting mechanism of the thermally driven inkjet printhead will now be described in detail. When a pulse of electric current flows through a heater formed of a resistive heating material, the heater generates heat, which instantaneously raises a temperature of ink that is adjacent to the heater up to 300° C. Accordingly, the ink boils and generates bubbles, which expand to press the ink that fills an ink chamber. Ink that is adjacent to a nozzle is ejected from the ink chamber through the nozzle as a droplet due to force from the bubbles.

The thermally driven inkjet printhead can be classified as either a bubble-through type inkjet printhead or a bubble-collapse type inkjet printhead. FIG. 1 illustrates a conventional bubble-through type inkjet printhead, and FIG. 2 illustrates a conventional bubble-collapse type inkjet printhead.

Referring to FIG. 1, in the bubble-through type inkjet printhead that is currently being commercialized, a bubble B1 generated inside an ink chamber 22 by a heater 15 expands through a nozzle 32, thereby ejecting ink. In the bubble-through type inkjet printhead, a total thickness of a chamber layer 20 and a nozzle layer 30 sequentially stacked on top of a substrate 10 is about 34 um or less. A direction in which the ink droplet is ejected from the bubble-through type inkjet printhead described above is greatly affected by a processed surface of the nozzle 32. Thus, the direction of the ink droplet can become unstable. In an effort to overcome this problem, the bubble-collapse type inkjet printhead, as illustrated in FIG. 2, has been developed. In the bubble-collapse type inkjet printhead, a bubble B2 generated inside an ink chamber 52 by a heater 45 expands to a maximum inside the ink chamber 52 or a nozzle 62 and then contracts to eject ink. In the bubble-collapse type inkjet printhead, a total thickness of a chamber layer 50 and a nozzle layer 60 sequentially stacked on top of a substrate 40 is about 35 μm or more. However, print quality decreases as the thickness of the chamber layer 50 and the nozzle layer 60 increases in the bubble-collapse type inkjet printhead described above. In particular, if the thickness of the chamber layer 50 is increased, a distance between the heater 45 and the nozzle 62 increases, thereby reducing a nozzle effect of ink ejected by the nozzle 62 that collects the ink. As a result, a direction of the ejected ink droplet is inaccurate, thereby lowering the print quality. If the thickness of the nozzle layer 60 is increased, fluid resistance inside the nozzle 62 increases. Consequently, a droplet ejection speed is decreased, thereby causing inferior ejection ability. In order to improve the droplet ejection speed, more power is required, and a size of the heater must be increased. Therefore, a thermally driven inkjet printhead with print quality that is improved over the print quality of the conventional bubble-collapse type inkjet printhead is needed.

### SUMMARY OF THE INVENTION

The present general inventive concept provides a thermally driven inkjet printhead with improved print quality.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a thermally driven inkjet printhead. The inkjet printhead includes a substrate, a heater formed on the substrate, a chamber layer stacked on the substrate to define an ink chamber on an upper portion of the heater and an ink feed hole to supply ink to the ink chamber at one side thereof, an intermediate layer stacked on the chamber layer in which a through hole connected to the ink chamber is formed, and a nozzle layer stacked on the intermediate layer in which a nozzle connected to the through hole is formed. The through hole is connected to the ink feed hole and has a smaller cross-sectional area than a size of the heater.

A total thickness of the chamber layer, the intermediate layer, and the nozzle layer may be 35 um or more.

The through hole may be formed above the ink chamber, and the nozzle may be formed above the through hole. The heater may be disposed on a center floor of the ink chamber.

A cross-section of the through hole may be a circle or a polygon. The intermediate layer may be made of a photosensitive polymer.

The intermediate layer may be stacked on the chamber layer to define the ink feed hole together with the chamber layer. An ink inlet, which connects the ink feed hole and the through hole, may be formed in the intermediate layer.

The foregoing and/or other aspects of the present general inventive concept are also achieved by providing an inkjet printhead, including a substrate having a heater disposed thereon, a first layer disposed on the substrate to define an ink chamber having a first cross sectional area to temporarily store ink, a second layer disposed on the first layer to define a through hole extending to the ink chamber and having a second cross sectional area, and a third layer disposed on the second layer to define a nozzle having a third cross sectional area communicating with the through hole, wherein the second cross sectional area is less than the first cross sectional area and greater than the third cross sectional area.

The foregoing and/or other aspects of the present general inventive concept are also achieved by providing an inkjet printhead, including a substrate having a heater disposed thereon, at least two intermediate layers to form an ink chamber having a base portion and an upper portion, which is smaller than the base portion, an ink feed hole disposed at a side of the ink chamber to provide ink to the ink chamber via the at least two intermediate layers, and a nozzle layer disposed on the at least two intermediate layers to define a nozzle above the ink chamber.

The foregoing and/or other aspects of the present general inventive concept are also achieved by providing an inkjet printhead, including a substrate having a heater disposed thereon, a chamber layer disposed on the substrate about the heater to define an ink chamber having a through hole including a stepped portion therein that decreases in width as the stepped portion extends away from the heater, and a nozzle layer having a nozzle in which the portion of the chamber layer having the decreased width extends thereto.

The foregoing and/or other aspects of the present general inventive concept are also achieved by providing a method of fabricating an inkjet printhead, the method including forming a first layer on a substrate having a heater disposed thereon to define an ink chamber having a first cross sectional area to temporarily store ink, forming a second layer on the first layer to define a through hole having a second cross sectional area, and forming a third layer on the second layer to define a nozzle having a third cross sectional area, wherein the second cross sectional area is less than the first cross sectional area and greater than the third cross sectional area.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic cross-sectional view illustrating a conventional thermally driven inkjet printhead;

FIG. 2 is a schematic cross-sectional view illustrating another conventional thermally driven inkjet printhead;

FIG. 3 is a schematic plan view illustrating a thermally driven inkjet printhead according to an embodiment of the present general inventive concept;

FIG. 4 is a cross-sectional view illustrating the thermally driven inkjet printhead in FIG. 3 along line IV-IV′;

FIG. 5 is a cross-sectional view illustrating the thermally driven inkjet printhead in FIG. 3 along line V-V′; and

FIG. 6 is a cross-sectional view illustrating the thermally driven inkjet printhead in FIG. 3 along line VI-VI′.

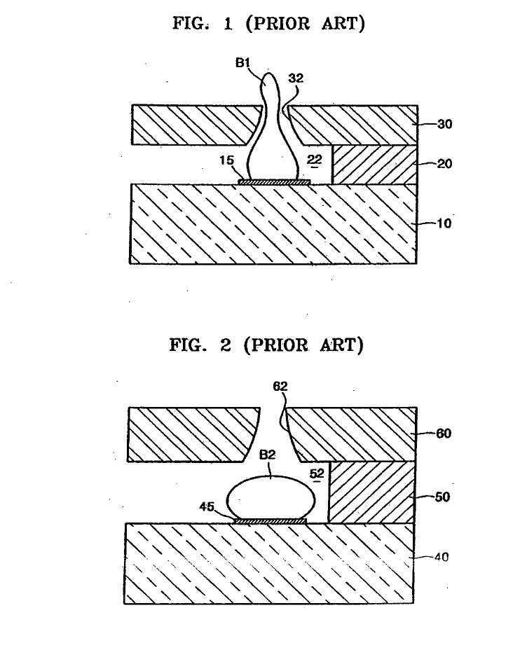

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the drawings, sizes and thicknesses of components and/or layers are exaggerated for clarity. It should also be understood that when a layer is referred to as being “on” another layer or substrate, it can be directly on the other layer or substrate, or intervening layers may also be present.

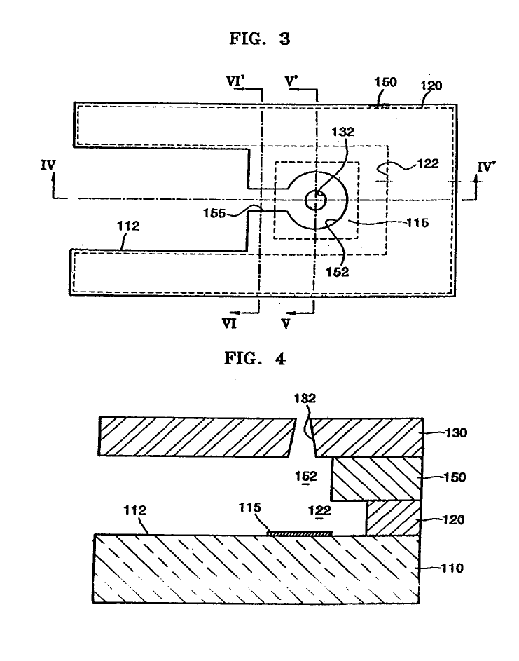

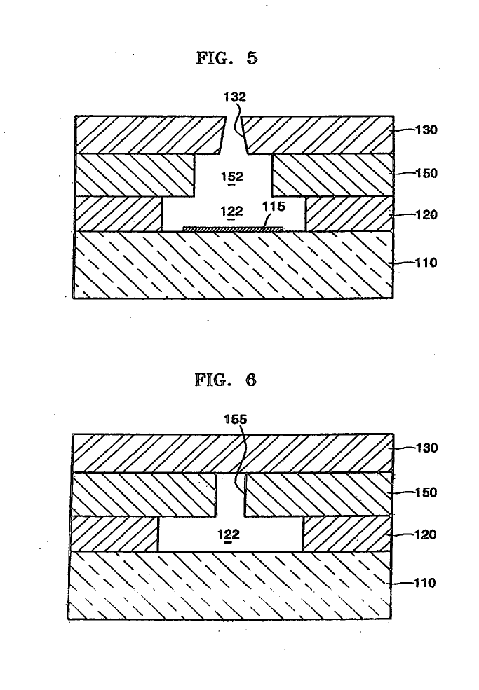

FIG. 3 is a schematic plan view illustrating a thermally driven inkjet printhead according to an embodiment of the present general inventive concept. FIG. 4 is a cross-sectional view illustrating the thermally driven inkjet printhead of FIG. 3 along line IV-IV′, FIG. 5 is a cross-sectional view of the thermally driven inkjet printhead of FIG. 3 along line V-V′, and FIG. 6 is a cross-sectional view of the thermally driven inkjet printhead of FIG. 3 along line VI-VI′.

Referring to FIGS. 3 through 6, the thermally driven inkjet printhead includes a chamber layer 120, an intermediate layer 150, and a nozzle layer 130 sequentially stacked on a substrate 110. Generally, the substrate 110 may be a silicon substrate. A heater 115, which generates bubbles by heating ink, is formed on a surface of the substrate 110.

The thermally driven inkjet printhead according to the present embodiment is a bubble-collapse type printhead in which a bubble generated by the heater 115 expands to a maximum in an ink chamber 122 formed in the chamber layer 120, a through hole 152 formed in the intermediate layer 150, and/or a nozzle 132 formed in the nozzle layer 130, and then the bubble shrinks to eject ink. Accordingly, a total thickness of the chamber layer 120, the intermediate layer 150, and the nozzle layer 130 may be about 35 urn or more.

The chamber layer 120 stacked on the substrate 110 defines the ink chamber 122 above the heater 115. Also, the chamber layer 120 defines an ink feed hole 112, through which ink is supplied to the ink chamber 122, at one side of the ink chamber 122. Accordingly, the ink supplied via the ink feed hole 112 fills the ink chamber 122. The heater 115 may be formed on the surface of the substrate 110 at a center of the ink chamber 122.

The intermediate layer 150 is stacked on the chamber layer 120. The through hole 152 connected to the ink chamber 122 is formed in the intermediate layer 150. The through hole 152 may be formed above the ink chamber 122. The intermediate layer 150 may be stacked on the chamber layer 120 to define the ink feed hole 112 together with the chamber layer 120. Here, the through hole 152 may be formed to be connected to the ink feed hole 112. To achieve this, an ink inlet 155 connecting the through hole 152 and the ink feed hole 112 may be formed in the intermediate layer 150. As a result, the intermediate layer 150 is filled with ink supplied by the ink feed hole 112 via the ink inlet 155.

The through hole 152 positioned between the ink chamber 122 and the nozzle 132 simultaneously performs the functions of the ink chamber 122 and the nozzle 132. Specifically, the through hole 152 further supplies ink, along with the ink chamber 122, to an upper portion of the heater 115 to satisfy an amount of a droplet required when the ink is ejected. Simultaneously, the through hole 152 concentrates the ink to eject the ink through the nozzle 132, thereby improving the ejection ability of the inkjet printhead. Here, a cross-sectional area of the through hole 152 may be smaller than a size of the heater 115 so that the through hole 152 can act as the nozzle 132. Although the cross-section of the through hole 152 illustrated in FIG. 3 is a circle, the general inventive concept is not intended to be limited thereto, and the cross-section of the through hole 152 may alternatively be a polygon such as a quadrangle, a pentagon, etc.

The intermediate layer 150 may be made of a photosensitive polymer. The intermediate layer 150 may be formed by spin-coating a fluidic photosensitive polymer or laminating a dry film made of photosensitive polymer on the chamber layer 120 and then patterning the photosensitive polymer into a predetermined form.

The nozzle layer 130 is stacked on the intermediate layer 150. The nozzle 132 through which ink is ejected is formed in the nozzle layer 130 to be connected to the through hole 152. The nozzle 132 may be disposed above the through hole 152.

Therefore, by forming the through hole 152, which performs the functions of the ink chamber 122 and the nozzle 132, in the intermediate layer 150 interposed between the chamber layer 120 and the nozzle layer 130, print performance can be improved in the bubble-collapse type inkjet printhead.

As described above, in the thermally driven inkjet printhead according to embodiments of the present general inventive concept, an intermediate layer is interposed between a chamber layer and a nozzle layer. A through hole is formed with a smaller size than a heater in the intermediate layer to simultaneously perform functions of both an ink chamber and a nozzle. Accordingly, the through hole supplies a predetermined volume of ink to an upper portion of the heater such that an amount of ink used for ink ejection can be satisfied. In addition, the through hole concentrates the ink to eject the ink through the nozzle such that ejection ability of the inkjet printhead can be improved. Consequently, the problem of print performance in a conventional bubble-collapse type inkjet printhead can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A thermally driven inkjet printhead, comprising:
a substrate;
a heater formed on the substrate;
a chamber layer stacked on the substrate defining an ink chamber on an upper portion of the heater and an ink feed hole to supply ink to the ink chamber at one side of the ink chamber;
an intermediate layer stacked on the chamber layer in which a through hole connected to the ink chamber is formed; and
a nozzle layer stacked on the intermediate layer in which a nozzle connected to the through hole is formed,
wherein the through hole is connected to the ink feed hole and has a smaller cross-sectional area than a size of the heater.

2. The thermally driven inkjet printhead of claim 1, wherein a total thickness of the chamber layer, the intermediate layer, and the nozzle layer is 35 um or more.

3. The thermally driven inkjet printhead of claim 1, wherein the through hole is formed above the ink chamber, and the nozzle is formed above the through hole.

4. The thermally driven inkjet printhead of claim 3, wherein the heater is disposed on the substrate at a center of the ink chamber.

5. The thermally driven inkjet printhead of claim 1, wherein a cross-section of the through hole comprises a circle or a polygon.

6. The thermally driven inkjet printhead of claim 1, wherein the intermediate layer comprises a photosensitive polymer.

7. The thermally driven inkjet printhead of claim 1, wherein the intermediate layer is stacked on the chamber layer to define the ink feed hole together with the chamber layer.

8. The thermally driven inkjet printhead of claim 1, wherein an ink inlet, which connects the ink feed hole and the through hole, is formed in the intermediate layer.

9. An inkjet printhead, comprising:
a substrate having a heater disposed thereon;
a first layer disposed on the substrate to define an ink chamber having a first cross sectional area to temporarily store ink;
a second layer disposed on the first layer to define a through hole extending to the ink chamber and having a second cross sectional area; and
a third layer disposed on the second layer to define a nozzle having a third cross sectional area communicating with the through hole, wherein the second cross sectional area is less than the first cross sectional area and greater than the third cross sectional area.

10. The inkjet printhead of claim 9, wherein the second cross sectional area is less than a cross sectional area of the heater.

11. The inkjet printhead of claim 9, wherein the heater generates a bubble to fill the ink chamber and the through hole such that when the bubble shrinks, one or more ink droplets are ejected via the nozzle.

12. The inkjet printhead of claim 9, further comprising:
a ink feed hole disposed at one portion of the through hole and the ink chamber such that both the through hole and the ink chamber supply ink received via the ink feed hole to the heater.

13. The inkjet printhead of claim 12, wherein the through hole comprises an ink inlet to provide a path through which ink from the ink feed hole flows to the through hole.

14. The inkjet printhead of claim 13, wherein the path formed by the ink inlet is about as wide as the nozzle.

15. The inkjet printhead of claim 9, wherein the through hole concentrates ink received from the ink chamber to provide the concentrated ink to the nozzle.

16. An inkjet printhead, comprising:
a substrate having a heater disposed thereon;
at least two intermediate layers to form an ink chamber having a base portion and an upper portion, which is smaller than the base portion;
an ink feed hole disposed at a side of the ink chamber to provide ink to the ink chamber via the at least two intermediate layers; and
a nozzle layer disposed on the at least two intermediate layers to define a nozzle above the ink chamber.

17. The inkjet printhead of claim 16, wherein one or more of the at least two intermediate layers are formed of a photosensitive polymer.

18. An inkjet printhead, comprising:
a substrate having a heater disposed thereon;
a chamber layer disposed on the substrate about the heater to define an ink chamber having a stepped portion that decreases in width further away from the heater; and
a nozzle layer including a nozzle in which the portion of the chamber layer having the decreased width extends thereto.

19. The inkjet printhead of claim 18, wherein the stepped portion of the ink chamber comprises a through hole and includes an ink feed hole at a portion thereof, the ink feed hole being smaller at the portion having the decreased width.

20. A method of fabricating an inkjet printhead, the method comprising:
forming a first layer on a substrate having a heater disposed thereon to define an ink chamber having a first cross sectional area to temporarily store ink;
forming a second layer on the first layer to define a through hole having a second cross sectional area; and
forming a third layer on the second layer to define a nozzle having a third cross sectional area, wherein the second cross sectional area is less than the first cross sectional area and greater than the third cross sectional area.

21. The method of claim 20, wherein the forming of the second layer comprises forming a photosensitive polymer on the first layer and patterning the photosensitive polymer.
